(19) United States
(12) Patent Application Publication
(10) Pub. No.: US 2026/0140263 A1
(43) Pub. Date: May 21, 2026

(54) METHOD AND SERVER FOR CALIBRATING CAMERA AND LIDAR BASED ON DISTANCE AND ANGLE OF LIDAR POINT PROJECTION

(71) Applicant: MOBILTECH, Seoul (KR)

(72) Inventors: Jae Seung KIM, Seoul (KR); Hyung gon YOO, Suwon-si (KR); Sun Jae JEONG, Hwaseong-si (KR); Min Kyoung KIM, Seoul (KR); Soo Hwan KIM, Cheonan-si (KR)

(73) Assignee: MOBILTECH, Seoul (KR)

(21) Appl. No.: 19/347,852

(22) Filed: Oct. 2, 2025

(30) Foreign Application Priority Data
Nov. 15, 2024 (KR) 10-2024-0163385

(51) Int. Cl. G01S 17/894; G01S 7/48; G01S 7/497

(52) U.S. Cl. CPC G01S 17/894; G01S 7/4808; G01S 7/497

(57) ABSTRACT

The disclosure relates to a server and a calibration method for performing calibration between a camera sensor and a LiDAR sensor. The server includes at least one processor configured to acquire an image from a camera and point cloud data from a LiDAR sensor, extract feature points of a calibration board included in the image and the point cloud data, and perform calibration based on the feature points. The processor generates a target plane by using a predetermined RANSAC algorithm, and projects the point cloud data onto the target plane by using perspective projection or orthogonal projection according to a relationship between a ray direction of the LiDAR sensor and a normal vector of the target plane. The processor further optimizes rotation and translation parameters by using a Particle Swarm Optimization (PSO) algorithm. This enables improved calibration accuracy, reduced sensitivity to noise, and robust operation in various environments.

### CROSS-REFERENCE TO RELATED APPLICATIONS AND CLAIM OF PRIORITY

The present application claims the benefit of priority to Korean Patent Application No. 10-2024-0163385, filed on Nov. 15, 2024, the entire disclosure of which is incorporated herein by reference.

### TECHNICAL FIELD

The present disclosure relates to the field of sensor fusion technology, and more particularly to a method for calibrating a camera and a Light Detection and Ranging (LiDAR) sensor by using distance information and angle information, and to a data generation apparatus configured to perform such calibration.

### BACKGROUND

In various fields such as autonomous driving, robotic navigation, and three-dimensional environment reconstruction, an increasing number of systems employ both LiDAR sensor and a camera. The LiDAR sensor is configured to measure three-dimensional spatial information with high accuracy by using laser beams, and the camera is configured to provide rich color and texture information. To effectively fuse data obtained from the two sensors, a calibration process that aligns coordinate systems of the respective sensors with precision is essential.

Conventional calibration methods for a LiDAR sensor and a camera primarily employ feature points of a checkerboard to calculate parameters of the camera and the LiDAR sensor. However, the conventional methods fail to adequately consider inherent characteristics of point cloud data generated by the LiDAR sensor, and such failure causes degradation of calibration accuracy.

In particular, the point cloud data obtained from the LiDAR sensor is based on distance information and angle information measured by laser beams. Therefore, a relationship between a position of the LiDAR sensor and each measured point must be considered. Conventional orthogonal projection methods ignore such characteristics of the point cloud data, and such ignorance causes reduced accuracy. Specifically, when a target plane is not perpendicular to a central axis of the LiDAR sensor or when the target plane is located close to the LiDAR sensor, projection of the point cloud data results in inaccurate calibration.

Accordingly, there is a need for a calibration method and a data generation apparatus that improve calibration accuracy by taking into account both distance characteristics and angle characteristics of the LiDAR point cloud data.

### ACKNOWLEDGMENT OF GOVERNMENT SUPPORT

This work was supported by the Technology Innovation Program (or Industrial Strategic Technology Development Program-Material Parts Technology Development (R&D)) (RS-2024-00508189, Development of Compact High-Resolution Wide-Angle Fusion LiDAR Sensors Applicable to Multiple Field Robots) funded By the Ministry of Trade Industry & Energy (MOTIE, Korea)

### SUMMARY

The present disclosure has been made to address the problems described above. An object of the present disclosure is to provide a method and a data generation apparatus that enable accurate and efficient calibration between a camera and a Light Detection and Ranging (LiDAR) sensor by analyzing both distance characteristics and angle characteristics of point cloud data acquired from the LiDAR sensor.

According to one embodiment, a calibration method includes: extracting, by a data generation apparatus, one frame of an image captured by the camera and one frame of point cloud data acquired by the LiDAR sensor; identifying, by the data generation apparatus, feature points of a calibration board included in the extracted image and the extracted point cloud data; and performing, by the data generation apparatus, calibration of the camera and the LiDAR sensor based on the identified feature points to align coordinate systems of the camera and the LiDAR sensor.

Performing the calibration may include generating, by the data generation apparatus, a target plane by applying a Random Sample Consensus (RANSAC) algorithm based on the feature points of the calibration board, and projecting the LiDAR point cloud data onto the target plane by using a distance-and-angle-based projection method. Performing the calibration may further include calculating extrinsic parameters including a rotation value and a translation value separately, based on the feature points included in the image and the point cloud data, and aligning the camera and the LiDAR sensor by using the calculated extrinsic parameters.

In one embodiment, when an angle between a ray direction of the LiDAR sensor and a normal vector of the target plane exceeds a predetermined angle, the point cloud data is projected onto the target plane by using an angle-based projection method, thereby improving calibration accuracy. In another embodiment, when a distance between the LiDAR sensor and the target plane is less than a predetermined distance, the point cloud data is projected onto the target plane by using a distance-based projection method, thereby enhancing calibration precision.

According to another embodiment, a data generation apparatus configured to perform calibration between the camera and the LiDAR sensor includes a memory and at least one processor communicatively coupled to the memory. The at least one processor is configured to extract one frame of the image and one frame of the point cloud data, identify the feature points of the calibration board, perform calibration of the camera and the LiDAR sensor based on the identified feature points, generate the target plane by applying the RANSAC algorithm, and project the point cloud data onto the target plane by using the distance-and-angle-based projection method.

According to the present disclosure, parameters of the camera and the LiDAR sensor can be calibrated with improved accuracy and efficiency. By employing a projection method that reflects distance and angle characteristics of LiDAR data, the calibration faithfully reflects a ray-casting process of the LiDAR sensor. The calibration method according to the present disclosure enhances performance of autonomous driving systems, robotic navigation systems, and three-dimensional environment reconstruction systems that employ both a camera and a LiDAR sensor.

### BRIEF DESCRIPTION OF THE DRAWINGS

The drawings accompanying the present specification illustrate embodiments of the present disclosure and, together with the description, serve to explain principles of the disclosure. In the drawings:

FIG. 1 illustrates a configuration of a data generation system according to an embodiment of the present disclosure.

FIG. 2 illustrates a logical configuration of a data generation apparatus according to an embodiment of the present disclosure.

FIG. 3 illustrates a hardware configuration of a data generation apparatus according to an embodiment of the present disclosure.

FIG. 4 illustrates a flowchart for explaining a calibration method of a camera and a Light Detection and Ranging (LiDAR) sensor according to an embodiment of the present disclosure.

FIGS. 5A-5B illustrate diagrams for explaining a perspective projection according to an embodiment of the present disclosure.

FIG. 6 illustrates a diagram for comparing effects of perspective projection and orthogonal projection according to an embodiment of the present disclosure.

FIGS. 7 and 8 illustrate diagrams for explaining operations of performing perspective projection under specific conditions according to an embodiment of the present disclosure.

### DETAILED DESCRIPTION

Technical terms used in the present specification are employed merely for describing specific embodiments and are not intended to limit the present disclosure. Unless expressly defined otherwise herein, technical terms used in the present specification shall be interpreted in accordance with meanings generally understood by a person skilled in the art to which the present disclosure pertains, and shall not be interpreted in an unduly broad sense or in an unduly narrow sense. Furthermore, if a technical term used in the present specification fails to accurately express the spirit of the present disclosure, the technical term shall be understood as being replaced with a technical term that can be properly understood by a person skilled in the art. General terms used in the present specification shall be interpreted according to dictionary definitions or according to the context in which the terms are used, and shall not be interpreted in an unduly narrow sense.

Singular expressions used in the present specification shall be construed to include plural expressions unless the context clearly dictates otherwise. Terms such as “comprises” and “has” used in the present specification shall not be construed as necessarily including all components or all steps described herein, but shall be construed as possibly excluding some components or steps or including additional components or steps.

Ordinal terms such as “first” and “second” may be used to describe various elements, but the elements shall not be limited by such terms. The terms are employed only to distinguish one element from another. For example, a first element may be referred to as a second element, and similarly, the second element may also be referred to as the first element, without departing from the scope of the present disclosure.

When an element is described as being “connected” or “coupled” to another element, the element may be directly connected or coupled to the other element, or an intervening element may be present. In contrast, when an element is described as being “directly connected” or “directly coupled” to another element, no intervening element shall be understood to be present.

Hereinafter, preferred embodiments of the present disclosure will be described in detail with reference to the accompanying drawings. In the drawings, identical or similar elements are assigned the same reference numerals regardless of figure numbers, and redundant descriptions thereof will be omitted. In describing the present disclosure, detailed descriptions of well-known techniques will be omitted if it is determined that such detailed descriptions would obscure the gist of the present disclosure. The accompanying drawings are provided only to facilitate understanding of the spirit of the present disclosure, and the scope of the present disclosure shall not be construed as being limited by the drawings. The scope of the present disclosure shall be construed to extend to all modifications, equivalents, and substitutions in addition to those illustrated in the drawings.

A Mobile Mapping System (MMS) may be mounted on a vehicle in order to acquire positional information and visual information of surrounding geographic features while the vehicle is in motion. The MMS may be configured based on information collected by various sensors, including a Global Positioning System (GPS) for acquiring positional and attitude information of a vehicle body, an Inertial Navigation System (INS), an Inertial Measurement Unit (IMU), a camera for collecting shape and texture information of geographic features, a Light Detection and Ranging (LiDAR) sensor, and other sensors.

However, the various sensors used to acquire, capture, or measure data as described above cannot be physically installed at an identical location, and since each sensor operates based on its own time information, synchronization among the sensors cannot be achieved.

Meanwhile, a Simultaneous Localization and Mapping (SLAM) system may estimate a pose of a vehicle while simultaneously constructing a three-dimensional map, based on information collected by the GPS, the INS, the IMU, the camera, the LiDAR sensor, and other sensors. However, conventional SLAM systems impose excessive computational load due to complex operations, and as a result, a significant amount of time is required for localization and map construction.

In order to overcome such limitations, the present disclosure provides various means for performing calibration among multiple sensors and for generating an accurate feature map.

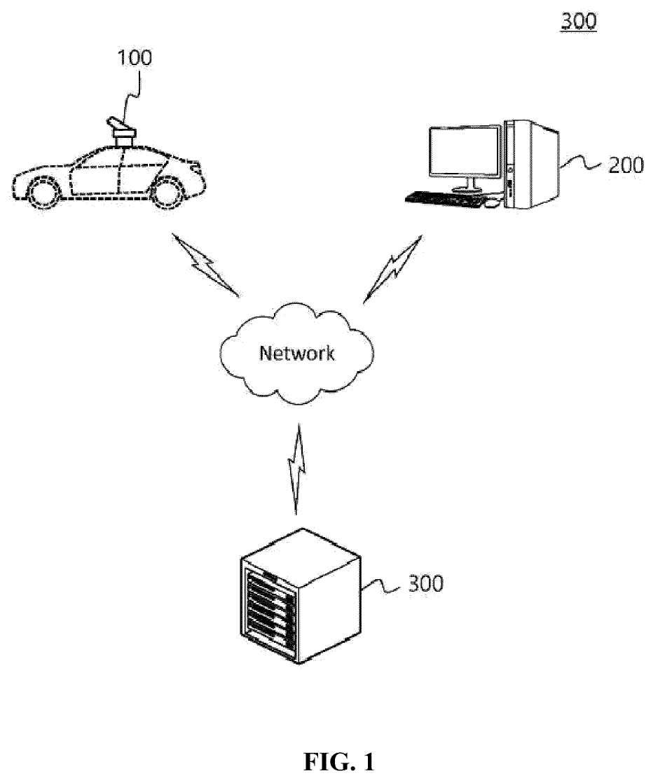

FIG. 1 illustrates a configuration of a data generation system according to an embodiment of the present disclosure. Referring to FIG. 1, a data generation system according to an embodiment of the present disclosure may include a data collection apparatus 100, a data generation apparatus 200, and a data processing apparatus 300.

According to an embodiment of the present disclosure, the data generation apparatus 200 may be implemented as a server. Components of the data generation system according to the embodiment of the present disclosure merely represent functionally distinguishable elements. Therefore, in an actual physical environment, two or more components may be integrated and implemented together, or one component may be divided and implemented separately.

Describing each component, the data collection apparatus 100 may be mounted on a vehicle and may cause collection of data required for map generation and learning data generation. The data collection apparatus 100 may include at least one of a LiDAR sensor, a camera, a radar, an Inertial Measurement Unit (IMU), and a Global Positioning System (GPS). However, the data collection apparatus 100 is not limited thereto, and various sensors capable of sensing information for generating a high-definition road map may be applied.

Specifically, the data collection apparatus 100 may cause acquisition of point cloud data from the LiDAR sensor and may cause acquisition of an image captured by the camera. In addition, the data collection apparatus 100 may cause acquisition of information related to position and pose from the IMU and the GPS.

The LiDAR sensor may cause emission of laser pulses around the vehicle, may cause detection of light reflected from objects located around the vehicle, and may generate point cloud data corresponding to a three-dimensional image of the surroundings of the vehicle.

The camera may cause acquisition of an image of a space corresponding to the LiDAR sensor. The camera may include one of a color camera, a Near InfraRed (NIR) camera, a Short Wavelength InfraRed (SWIR) camera, and a Long Wavelength InfraRed (LWIR) camera.

The IMU may include an acceleration sensor and a gyroscope, and in some cases, may further include a magnetometer, and may cause detection of changes in acceleration resulting from changes in motion of the data collection apparatus 100.

The GPS may receive signals transmitted from satellites and may cause measurement of a position of the data collection apparatus 100 by using triangulation.

The data collection apparatus 100 may be installed on a vehicle or on an aerial apparatus. For example, the data collection apparatus 100 may be installed on an upper portion of a vehicle to collect surrounding point cloud data or images, or may be installed on a lower portion of an aerial apparatus to collect point cloud data or images of objects on the ground from the air. The data collection apparatus 100 may transmit the collected point cloud data or images to the data generation apparatus 200.

In a subsequent configuration, the data generation apparatus 200 may receive point cloud data acquired by the LiDAR sensor and images captured by the camera from the data collection apparatus 100. The data generation apparatus 200 may cause generation of a high-definition road map by using the received point cloud data and images, and may cause generation of learning data utilizing the high-definition road map.

Characteristically, according to one embodiment of the present disclosure, the data generation apparatus 200 may extract one frame of an image captured by the camera and one frame of point cloud data acquired by the LiDAR sensor, and may identify feature points of a calibration board included in each of the extracted image and the extracted frame of point cloud data. The data generation apparatus 200 may cause calibration of the camera and the LiDAR sensor based on the identified feature points.

According to another embodiment of the present disclosure, the data generation apparatus 200 may place point cloud data acquired from a LiDAR sensor mounted on a vehicle onto a predefined world coordinate system, and may extract a region to be used for calibration from the placed point cloud data. The data generation apparatus 200 may identify at least one object included in the extracted region, and may cause calibration of the point cloud data by fitting the point cloud corresponding to the identified at least one object to a pre-stored model.

According to still another embodiment of the present disclosure, the data generation apparatus 200 may obtain first point cloud data acquired from a first LiDAR sensor, a plurality of second point cloud data acquired from a plurality of second LiDAR sensors mounted on a vehicle traveling along a path on a reference map, and specification values of the first LiDAR sensor and the plurality of second LiDAR sensors. The data generation apparatus 200 may cause preprocessing of the first point cloud data and the plurality of second point cloud data, and may cause calibration of the preprocessed first point cloud data and the plurality of second point cloud data.

According to yet another embodiment of the present disclosure, the data generation apparatus 200 may cause generation of a first feature map based on point cloud data acquired from the LiDAR sensor and images captured by the camera, and may cause generation of a third feature map by mapping the first feature map to a second feature map generated from pre-stored point cloud data.

Although various embodiments of the present disclosure are described as being distinguished from one another and performing individual functions, the present disclosure is not limited thereto, and functions of the respective embodiments may be combined and applied together.

The data generation apparatus 200 having such features may be any apparatus that transmits and receives data to and from the data collection apparatus 100 and the data processing apparatus 300, and performs computation based on the transmitted and received data. For example, the data generation apparatus 200 may be a fixed computing device such as a desktop, a workstation, or a server, but is not limited thereto.

In a subsequent configuration, the data processing apparatus 300 may process a map generated by the data generation apparatus 200. For example, the data processing apparatus 300 may cause correction of facility information in the map generated by the data generation apparatus 200, or may cause removal of noise from the generated map. In addition, the data processing apparatus 300 may cause detection of a specific object from the generated map, or may cause lightweight processing of the data.

The data processing apparatus 300 having such features may be any apparatus that transmits and receives data to and from the data collection apparatus 100 and the data generation apparatus 200, and performs computation based on the transmitted and received data. For example, the data processing apparatus 300 may be a fixed computing device such as a desktop, a workstation, or a server, but is not limited thereto.

The data collection apparatus 100, the data generation apparatus 200, and the data processing apparatus 300, as described above, may transmit and receive data through a network composed of at least one of a secure dedicated line directly connecting the devices, a public wired communication network, or a mobile communication network. For example, the public wired communication network may include Ethernet, a Digital Subscriber Line (xDSL), a Hybrid Fiber Coax (HFC) network, and a Fiber To The Home (FTTH) network, but is not limited thereto. The mobile communication network may include Code Division Multiple Access (CDMA), Wideband CDMA (WCDMA), High Speed Packet Access (HSPA), Long Term Evolution (LTE), and fifth-generation (5G) mobile telecommunication, but is not limited thereto.

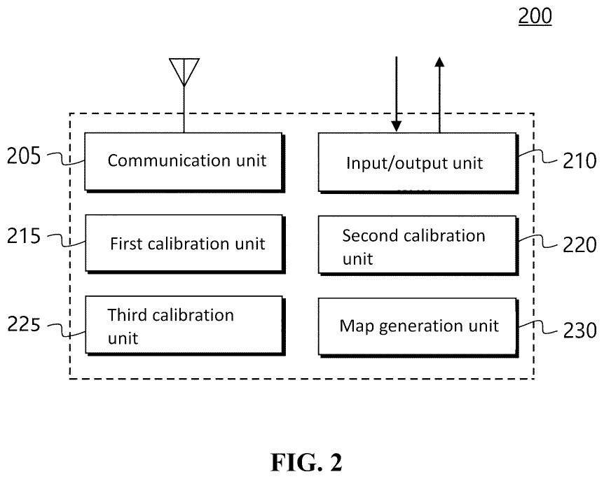

FIG. 2 illustrates a logical configuration of a data generation apparatus according to an embodiment of the present disclosure. Referring to FIG. 2, a data generation apparatus 200 according to an embodiment of the present disclosure may include a communication unit 205, an input/output unit 210, a first calibration unit 215, a second calibration unit 220, a third calibration unit 225, and a map generation unit 230.

Components of the data generation apparatus 200 merely represent functionally distinguishable elements. Therefore, in an actual physical environment, two or more components may be integrated and implemented together, or one component may be divided and implemented separately.

Describing each component, the communication unit 205 may transmit and receive data to and from the data collection apparatus 100 and the data processing apparatus 300. Specifically, the communication unit 205 may receive point cloud data acquired by the LiDAR sensor and images captured by the camera from the data collection apparatus 100.

In a subsequent configuration, the input/output unit 210 may receive signals from a user through a user interface (UI), or may output computation results to the outside. Specifically, the input/output unit 210 may receive setting information for calibration among sensors. In addition, the input/output unit 210 may output calibration results and a generated map.

In a subsequent configuration, a first calibration unit 215 may perform calibration between a camera and a Light Detection and Ranging (LiDAR) sensor. Specifically, the first calibration unit 215 may extract one frame of an image captured by the camera and one frame of point cloud data acquired by the LiDAR sensor. In this case, each of the extracted image and the extracted frame of point cloud data may include a calibration board.

The first calibration unit 215 may identify feature points of the calibration board included in each of the extracted image and the extracted frame of point cloud data. The calibration board may be a rectangular checkerboard including a border identification region formed of a material having an intensity greater than a predetermined value along a border of the checkerboard, and a top point identification region located at an uppermost portion of the border identification region and formed of a material having an intensity less than a predetermined value.

For example, the calibration board may include a high-luminance tape attached along the border of the checkerboard, the high-luminance tape being formed of a material having an intensity greater than the predetermined value, thereby forming the border identification region. In this case, a portion of the high-luminance tape positioned at the uppermost portion of the calibration board may be removed, thereby forming the top point identification region.

Specifically, the first calibration unit 215 may identify corners of the calibration board in the image captured by the camera, based on a size and a number of the calibration boards. For example, the first calibration unit 215 may extract the calibration board in the image by using a source checkerboard image corresponding to the calibration board, a number of internal corners per row and per column of the checkerboard, and an output array of detected corners, and may identify the corners of the extracted calibration board.

The first calibration unit 215 may identify points corresponding to corners of the calibration board according to a predetermined pattern, based on a feature point located at an uppermost portion or a lowermost portion of the calibration board, and may assign indices to the identified points. For example, the first calibration unit 215 may assign indices in a manner in which numbers increase toward the lower right based on the feature point located at the uppermost portion of the calibration board, or in a manner in which numbers increase toward the upper left based on the feature point located at the lowermost portion of the calibration board.

The first calibration unit 215 may detect the calibration board from the point cloud data based on the border identification region of the calibration board having a relatively high intensity, and may identify feature points within the detected calibration board. Specifically, the first calibration unit 215 may generate a target plane based on point clouds included in the border identification region, and may generate a plurality of straight lines by connecting outermost points positioned in each channel on the generated virtual plane. The first calibration unit 215 may detect vertices of the calibration board based on intersections of the generated plurality of straight lines, and may identify feature points of the calibration board based on the detected vertices.

The first calibration unit 215 may identify four vertices included in the calibration board, and may identify feature points of the calibration board based on a size and a number of calibration boards stored in advance. Feature points of the calibration board identified from the point cloud data may correspond to feature points identified from the image.

The first calibration unit 215 may match indices of feature points identified from the image to feature points identified from the LiDAR sensor, based on the top point identification region of the calibration board.

The first calibration unit 215 may perform calibration of the camera and the LiDAR sensor based on feature points identified from each of the image and the point cloud data. Specifically, the first calibration unit 215 may calculate extrinsic parameters including a rotation value and a translation value based on the feature points of the calibration board included in the image and the point cloud data, and may perform calibration based on the calculated extrinsic parameters.

The first calibration unit 215 may calculate the rotation value and the translation value separately. Preferably, the first calibration unit 215 may calculate the translation value after calculating the rotation value.

First, when the rotation value is defined as a rotation value from a first viewpoint to a second viewpoint, the rotation value may be calculated by using Equation (1) below.

$$\vert ( {f}_{1} * {Rf}_{1}^{′} ) ( {f}_{2} * {Rf}^{′} 2 ) ( {f}_{3} * {Rf}_{3}^{′} ) \vert = 0 \qquad [ Equation 1 ]$$

In Equation (1), R denotes the rotation value, and ƒ and ƒ′ denote rays from the first viewpoint and the second viewpoint, respectively, to feature points of the calibration board included in the point cloud data.

A translation value may be calculated by using a loss function based on a Re-Projection Error (RPE). The RPE may denote a degree of distortion of a point projected onto an image with respect to a point observed in the image.

In a subsequent configuration, a second calibration unit 220 may perform calibration of the LiDAR sensor and the Inertial Measurement Unit (IMU) by using features corresponding to a shape of a specific object included in point cloud data acquired from the LiDAR sensor. Specifically, the second calibration unit 220 may place the point cloud data acquired from the LiDAR sensor mounted on a vehicle onto a predefined world coordinate system.

In this case, the second calibration unit 220 may define the world coordinate system by using positional information measured from at least one of a Global Positioning System (GPS) and the IMU, acquired simultaneously with the point cloud data.

Next, the second calibration unit 220 may extract a region of the placed point cloud data to be used for calibration. Specifically, the second calibration unit 220 may extract a trajectory in which a heading standard deviation of GPS data representing an error of the GPS data is less than a predetermined value, and may extract a section including trajectories in which traveling directions of the vehicle are opposite to each other within the extracted trajectory.

Generally, the GPS data is post-processed by using multiple types of data such as the GPS itself, the IMU, a Distance Measurement Instrument (DMI), and base station information. However, even after post-processing by using other data, the GPS data may still contain errors due to effects of objects composed of highly reflective materials, such as tall buildings.

Calibration must be performed at a location where an error of GPS data is lowest in order to improve accuracy. Accordingly, the second calibration unit 220 may extract an optimal trajectory for calibration from the entire section.

When calibration is performed only on a section in which the vehicle travels in one direction among trajectories having a heading standard deviation less than a predetermined value, tilting is not considered, and a generated map may be distorted. Therefore, the second calibration unit 220 may extract a section including trajectories in which traveling directions of the vehicle are opposite to each other within the extracted trajectory.

For example, the second calibration unit 220 may generate heading standard deviation values by using 10-quantile, may extract trajectories belonging to the lower 10% of the heading standard deviation values, and may operate a sliding window of a predetermined size to check whether two or more separated trajectories are included in the window. When two or more trajectories are included in the window, the second calibration unit 220 may calculate average heading values of the respective trajectories to determine whether trajectories having opposite directions exist, and when they exist, the second calibration unit 220 may determine the corresponding section as an appropriate trajectory for calibration.

Next, the second calibration unit 220 may identify at least one object included in the extracted region. As an object to be used for calibration, a spherical shape that can reflect all of the x-axis, the y-axis, and the z-axis may be most appropriate. That is, a spherical shape may allow detection of tilting in any direction. However, in practice, objects having spherical shapes rarely exist.

Alternatively, when calibration is performed based on a wall, calibration may be possible in a direction perpendicular to the wall, but calibration may be difficult in a direction parallel to the wall. Therefore, two or more parallel walls must be used to perform calibration in the horizontal direction.

Accordingly, the second calibration unit 220 may use cylindrical objects, which exist relatively frequently in practice and which can be horizontally fitted, for calibration. Specifically, the second calibration unit 220 may identify cylindrical objects for horizontal fitting from the placed point cloud data. For example, the cylindrical objects may include street lights, utility poles, and traffic lights.

In addition, the second calibration unit 220 may identify a ground plane for vertical fitting from the placed point cloud data. In this case, the second calibration unit 220 may extract a region of a predetermined size based on a middle point of the extracted section, and may recognize the extracted region as the ground plane. That is, under an assumption that the vehicle equipped with the data collection apparatus 100 travels on a road, the second calibration unit 220 may extract a region of a predetermined size with respect to the x-axis and the y-axis from the middle point of the extracted trajectory, and may identify the region as the ground plane.

Next, the second calibration unit 220 may perform calibration of the point cloud data by fitting point clouds included in the identified at least one object to a pre-stored model. Specifically, the second calibration unit 220 may calculate a loss value for the cylindrical object by dividing a number of inlier points fitted to a pre-stored cylinder model corresponding to the cylindrical object by a number of point clouds included in the cylindrical object.

The second calibration unit 220 may calculate a loss for the ground plane by dividing a number of inlier points fitted to a pre-stored ground plane model by a number of point clouds included in the ground plane. The second calibration unit 220 may perform calibration of the point cloud data by using a loss function configured based on the loss for the cylindrical object and the loss for the ground plane.

Specifically, the second calibration unit 220 may configure the loss function as shown in the following code:

$$double loss = ( - 1 ) * pole\_loss + ( - 1 ) * ground\_loss$$

where pole_loss denotes a loss for the cylindrical object and ground_loss denotes a loss for the ground plane.

When a number of point clouds of an identified object is assumed to be n, and when i inlier points of a fitted cylinder model are obtained by applying a Random Sample Consensus (RANSAC) algorithm using the cylinder model, the loss for the object may be calculated by using the following code:

$$pole\_loss = i / n$$

When a number of point clouds of an identified ground plane is assumed to be n, and when i inlier points of a fitted ground plane model are obtained by applying the RANSAC algorithm using the ground plane model, the loss for the ground plane may be calculated by using the following code:

$$ground\_loss = i / n$$

Compared with vertical fitting that considers only the z-axis, horizontal fitting that considers both the x-axis and the y-axis may cause a problem in which the loss is calculated in an unbalanced manner. Such imbalance of the loss may hinder convergence to a correct value because the calibration process tends to search near a local minimum, rather than moving to another location after the loss has already been reduced by aligning the ground plane first.

Accordingly, the second calibration unit 220 may add a loss with respect to a ratio between the loss for the cylindrical object and the loss for the ground plane to the loss function.

Meanwhile, a loss with respect to a ratio between the loss for the cylindrical object and the loss for the ground plane may be calculated by using the following code:

```
double ratio_loss;
if(pole_loss > ground_loss)
  ratio_loss = ground_loss / pole_loss;
else // pole_loss < ground_loss
  ratio_loss = pole_loss / ground_loss;
```

Ultimately, the second calibration unit 220 may configure the loss function as shown in the following code:

$$double lambda = 0.5 ;$$

$$double loss = ( - 1 ) * pole\_loss + ( - 1 ) * ground\_loss + ( - 1 ) * ratio\_loss * lambda ;$$

where λ=0.5 may solve a problem in which the loss does not decrease further when the loss for the cylindrical object and the loss for the ground plane have the same value.

The second calibration unit 220 may perform calibration of the point cloud data by using the loss function through Particle Swarm Optimization (PSO). For example, the PSO may be configured as shown in the following code:

Algorithm 1: Particle Swarm Optimization

```
  Input: Objective function f : X → [symbol] [symbol]
        Termination condition w : X → [symbol] [symbol]
        Population size: X,
        Lower and upper bounds of the solution: b [symbol]   and b [symbol]
        Maximum influence values φ₁ and φ₂
  Output: Best solution g
  1 // Step 1: Initialization.
  2 Randomly initialize the population P = [x₁, x₂, ... , x_{N}] [symbol]
  3 Randomly initialize the particle’s velocity within [b [symbol]  , b [symbol]  ] [symbol]
  4 repeat
  5 | for i ∈ [1, 2, 3, ... , N] do
  6 | | // Step 2: Velocity Calculation [symbol]
  7 | | // d is a dimensionlity of the input space X [symbol]
  8 | | Generate a random vector r₁ ~ U[0, φ₁] [symbol]
  9 | | Generate a random vector r₂ ~ U[0, φ₁] [symbol]
$10 \vert \vert {v}_{i}^{( k + 1 )} ← \text{?} + {r}_{1} ( \text{?} - {x}_{i}^{( k )} ) + {r}_{2} ( g - {x}_{i}^{( k )} )$
11 | | // Step 3: Position Update
12 | | x [symbol]   ← x [symbol]   + v [symbol]
13 | | // Step 4: Evaluation
14 | | if f(x [symbol]  ) < f(p [symbol]  ) then
15 | | | p [symbol]   ← x [symbol]
16 | | | if f(p [symbol]  ) < f(g) then
17 | | | | z ← p,
28 | | | end
18 | | end
20 | end
21 until [symbol] (X) = = TRUE [symbol]
22 return g [symbol]
indicates data missing or illegible when filed
```

The second calibration unit 220 may also configure the loss function by optimizing based on a variance of point clouds of an identified object. Specifically, the second calibration unit 220 may configure at least one identified object as an octree, and may perform calibration of the point cloud data by using variance summation of leaf nodes of the configured octree as the loss.

In this case, the second calibration unit 220 may configure the loss function by adding a length of the z-axis of the point cloud data to the variance summation loss, and may perform calibration of the point cloud data based on the loss function. Through this process, the second calibration unit 220 may configure a continuous loss function in which randomness of ground plane fitting is removed.

In a subsequent configuration, a third calibration unit 225 may perform calibration among a plurality of LiDAR sensors. First, the third calibration unit 225 may obtain first point cloud data acquired from a first LiDAR sensor, a plurality of second point cloud data acquired from a plurality of second LiDAR sensors mounted on a vehicle traveling along a path on a reference map, and specification values of the first LiDAR sensor and the plurality of second LiDAR sensors.

For example, the first LiDAR sensor may be a LiDAR sensor used for generating the map, and the plurality of second LiDAR sensors may be LiDAR sensors mounted on a vehicle traveling along the path on the generated map to update the map. The plurality of second LiDAR sensors may include a LiDAR sensor configured to acquire point cloud data of a front side of the vehicle, a LiDAR sensor configured to acquire point cloud data of a rear side of the vehicle, and a LiDAR sensor mounted on a roof of the vehicle and configured to acquire 360-degree point cloud data.

Next, the third calibration unit 225 may perform preprocessing of the first point cloud data and the plurality of second point cloud data. Specifically, the third calibration unit 225 may voxelize the first point cloud data and the plurality of second point cloud data. Through this process, the third calibration unit 225 may reduce a difference in the number of points between the first LiDAR sensor and one of the plurality of second LiDAR sensors, and may remove noise.

In addition, the third calibration unit 225 may calculate an average value and a standard deviation based on distances among points in the first point cloud data and the plurality of second point cloud data, and may perform preprocessing by defining, as outliers, points having deviations greater than a predetermined value.

Since calibration is performed between the LiDAR sensor for generating the reference map and the LiDAR sensors mounted on the vehicle, point clouds corresponding to objects such as vehicles or people that do not exist on the reference map may cause calibration errors. Accordingly, the third calibration unit 225 may detect a ground plane from the plurality of second point cloud data, and may remove objects having a height greater than a predetermined value with respect to the detected ground plane. That is, the third calibration unit 225 may perform preprocessing of identifying and removing objects such as vehicles or people based on heights from the ground plane.

In addition, a matching score used in a Normal Distribution Transform (NDT) matching process described later may denote an average distance of points, where each point of one of the plurality of second point cloud data corresponds to a nearest point of the first point cloud data and the distance is less than a predetermined value. Accordingly, in order to reduce an error of z-axis values of the plurality of second LiDAR sensors, a weight of the ground plane must be as significant as that of walls and pillars.

Accordingly, the third calibration unit 225 may detect a ground plane from the plurality of second point cloud data, may approximate point clouds detected as the ground plane into a plane, and may interpolate additional points between the point clouds detected as the ground plane.

Next, the third calibration unit 225 may perform calibration of the preprocessed first point cloud data and the preprocessed plurality of second point cloud data. Specifically, the third calibration unit 225 may perform calibration of the plurality of second LiDAR sensors simultaneously by using multi-thread processing.

For calibration, the third calibration unit 225 may perform NDT (Normal Distribution Transform) matching with respect to each of the first point cloud data and the plurality of second point cloud data. In this case, the third calibration unit 225 may perform calibration by designating specification values of the first LiDAR sensor and the plurality of second LiDAR sensors as initial poses.

The NDT matching is an algorithm that calculates a transformation matrix by matching point cloud data, and may minimize errors of points by calculating the errors as a normal distribution when the first point cloud data and each of the plurality of second point cloud data overlap. That is, the NDT algorithm may register each of the plurality of second point cloud data with the first point cloud data, by dividing the first point cloud data into grids of a predetermined size, approximating point clouds in the grids as normal distributions, and optimizing a rotation value and a translation value in a direction that increases a probability that each point of the plurality of second point cloud data is located within the grids.

The third calibration unit 225 may determine registration between the first point cloud data and the plurality of second point cloud data by using a fitness score, which is a value obtained by summing errors of averages and covariances among voxels during an NDT matching process. The fitness score may denote an average distance of points, in which each point of one of the plurality of second point cloud data transformed according to a pose resulting from the NDT matching corresponds to a nearest point of the first point cloud data, and the distance is less than a predetermined value. The third calibration unit 225 may extract a pose at a point in time when the fitness score becomes lower than the predetermined value. The third calibration unit 225 may verify calibration by comparing the fitness score at a time when the NDT matching is completed with the predetermined value.

In addition, the third calibration unit 225 may designate a Region Of Interest (ROI) for each of the plurality of second point cloud data, and may perform NDT matching with the first point cloud data. In this case, the third calibration unit 225 may designate the ROI for each of the plurality of second point cloud data based on a coordinate system of the first point cloud data, and may align coordinate systems of the first point cloud data and the plurality of second point cloud data by using specification values of the first LiDAR sensor and the plurality of second LiDAR sensors before designating the ROI. The third calibration unit 225 may determine registration between the first point cloud data and the plurality of second point cloud data by using the fitness score of the designated ROI, and may extract a pose at a point in time when the fitness score becomes lower than the predetermined value. For example, the third calibration unit 225 may receive, as an ROI, a region that is expected to remain stationary from an operator.

The third calibration unit 225 may perform NDT matching while changing yaw values of each of the plurality of second point cloud data by a predetermined angle, and may extract a pose at a point in time when the fitness score becomes lower than the predetermined value. The third calibration unit 225 may then re-input the extracted pose as an initial pose for the NDT matching.

For example, the third calibration unit 225 may perform NDT matching while changing a yaw value of one of the plurality of second LiDAR sensors within a range of ±3° in increments of 0.1°, and may obtain a minimum fitness score and a pose at the time of the minimum fitness score. The third calibration unit 225 may re-input the minimum fitness score and the pose at the time of the minimum fitness score as an initial pose for the NDT matching, and may adopt the pose at a time when the pose converges through repeated NDT matching as a result.

In a subsequent configuration, a map generation unit 230 may generate a feature map by mapping feature points of an image captured by a camera onto point cloud data acquired by a LiDAR sensor. To this end, the map generation unit 230 may generate a first feature map based on point cloud data acquired from the LiDAR sensor and the image captured by the camera.

Specifically, the map generation unit 230 may acquire the point cloud data and the image by using the LiDAR sensor mounted on a vehicle and the camera installed at the same location as the LiDAR sensor. The map generation unit 230 may extract feature points from the acquired image and may generate the first feature map composed of the extracted feature points. The map generation unit 230 may extract the feature points based on brightness continuity of pixels that exist within a predetermined range from each pixel included in the image.

That is, when pixels brighter than a specific pixel by more than a predetermined value are continuously present at least n times, or when pixels darker than the specific pixel by more than the predetermined value are continuously present at least n times, the map generation unit 230 may determine the specific pixel as a corner point. To this end, the map generation unit 230 may determine whether a pixel is a corner point by using a decision tree. Specifically, the map generation unit 230 may classify brightness values of a pixel into three values, namely darker than the specific pixel, similar to the specific pixel, and brighter than the specific pixel, and may represent a brightness distribution of circumferential pixels as a sixteen-dimensional ternary vector. The map generation unit 230 may input the represented ternary vector into the decision tree and may classify whether the pixel is a corner point.

In addition, the map generation unit 230 may sequentially reduce the image to a predetermined scale, apply blurring to the reduced image, extract contours and corners included in the image by using a Difference of Gaussian (DoG) function, extract pixels corresponding to local maxima and minima of the extracted contours and corners, and extract the pixels having the local maxima and minima as feature points.

Furthermore, the map generation unit 230 may set a window around each pixel included in the image, and may detect a corner by moving the window by a predetermined distance in predetermined directions. For example, the map generation unit 230 may calculate an image variation amount when the window is moved by one pixel in four directions, namely vertical, horizontal, left diagonal, and right diagonal, may set a minimum value of the image variation amounts as an image variation amount value of the pixel, and may classify a point at which the set minimum value becomes a local maximum as a corner point.

As a result, the map generation unit 230 may generate the feature map based on feature points extracted from brightness continuity and located at detected corners. That is, the map generation unit 230 may generate the first feature map composed only of the feature points extracted from the image.

Next, the map generation unit 230 may generate a third feature map by mapping the first feature map to a second feature map generated from pre-stored point cloud data. Specifically, the map generation unit 230 may map the first feature map to the second feature map based on positional information and pose information of point cloud data acquired simultaneously with the image for generating the first feature map.

The second feature map may be a point cloud map generated by using point cloud data acquired by the same equipment that acquires the image and the point cloud data for generating the first feature map. Accordingly, the map generation unit 230 may omit a pose optimization process when mapping the first feature map to the second feature map. As a result, the map generation unit 230 may not only generate a lightweight feature map composed only of feature points, but also generate the third feature map at a high speed.

After generating the third feature map, the map generation unit 230 may receive at least one image in real time for position estimation. The map generation unit 230 may extract feature points by analyzing the received at least one image in real time. The map generation unit 230 may extract feature points from the image in the same manner as the feature points are extracted for generating the first feature map described above.

The map generation unit 230 may estimate a position on the real-time received image by matching the extracted feature points to the third feature map. In this case, the map generation unit 230 may estimate a pose of the camera of the data collection apparatus based on information regarding the feature points of the real-time received at least one image and the feature points of the third feature map. For example, the map generation unit 230 may calculate a current position and pose on the image by using a pnpsolver function. That is, the map generation unit 230 may estimate the position and pose of the camera capturing the real-time received image based on the feature points of the real-time received image and the feature points of the third feature map.

When position estimation for a first image among the at least one image fails, the map generation unit 230 may estimate a position of the first image based on a pose of a second image for which position estimation was successful previously. That is, the map generation unit 230 may predict a position of an image for which position estimation has failed based on a position and pose of a previously captured image.

The real-time received at least one image may be an image captured by a terminal equipped with a camera and an Inertial Measurement Unit (IMU). In this case, the map generation unit 230 may improve accuracy of position and pose estimation for the image for which position estimation has failed by reflecting the pose measured by the IMU based on the pose of the second image.

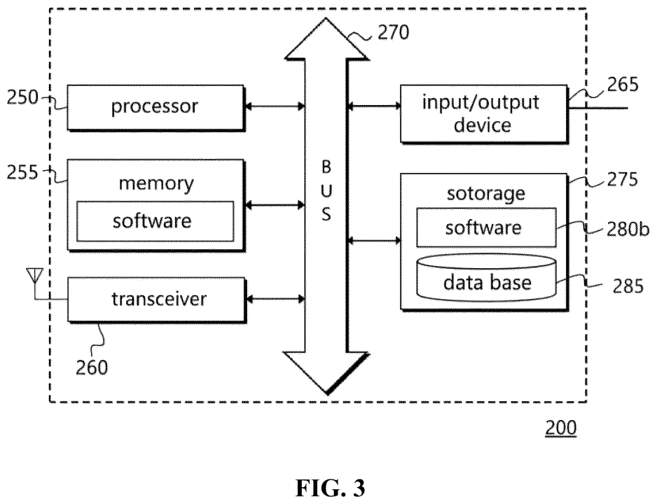

FIG. 3 illustrates a hardware configuration of a data generation apparatus according to an embodiment of the present disclosure. Referring to FIG. 3, the data generation apparatus 200 may include a processor 250, a memory 255, a transceiver 260, an input/output device 265, a data bus 270, and a storage 275.

The processor 250 may implement operations and functions of the data generation apparatus 200 based on instructions of software 280a resident in the memory 255. The memory 255 may load the software 280a implementing the method according to the present disclosure. The transceiver 260 may transmit and receive data to and from the data collection apparatus 100 and the data processing apparatus 300.

The input/output device 265 may receive data required for operation of the data generation apparatus 200 and may output generated results. The data bus 270 may be connected to the processor 250, the memory 255, the transceiver 260, the input/output device 265, and the storage 275, and may serve as a transfer path for delivering data among the respective components.

The storage 275 may store an Application Programming Interface (API), library files, and resource files required for execution of the software 280a implementing the method according to the present disclosure. The storage 275 may also store software 280b implementing the method according to the present disclosure. Furthermore, the storage 275 may store information required for performing a calibration method and a map generation method. In particular, the storage 275 may include a database 285 storing a program for performing the calibration method and the map generation method.

According to one embodiment of the present disclosure, the software 280a or 280b resident in the memory 255 or stored in the storage 275 may be a computer program recorded in a computer-readable recording medium that causes the processor 250 to execute: a step of extracting a calibration board from each of an image captured by a camera and point cloud data acquired by a LiDAR sensor; a step of identifying feature points of the calibration board included in each of the image and the point cloud data; and a step of performing calibration of the camera and the LiDAR sensor based on the identified feature points.

According to another embodiment of the present disclosure, the software 280a or 280b resident in the memory 255 or stored in the storage 275 may be a computer program recorded in the computer-readable recording medium that causes the processor 250 to execute: a step of placing point cloud data acquired from a LiDAR sensor mounted on a vehicle onto a predefined world coordinate system; a step of extracting a region to be used for calibration from the placed point cloud data; a step of identifying at least one object included in the extracted region; and a step of performing calibration of the point cloud data by fitting point clouds included in the identified at least one object to a pre-stored model.

According to another embodiment of the present disclosure, the software 280a or 280b resident in the memory 255 or stored in the storage 275 may be a computer program recorded in a computer-readable recording medium that causes the processor 250 to execute: a step of obtaining first point cloud data acquired from a first LiDAR sensor, a plurality of second point cloud data acquired from a plurality of second LiDAR sensors mounted on a vehicle traveling along a path on a reference map, and specification values of the first LiDAR sensor and the plurality of second LiDAR sensors, in order to generate the reference map; a step of performing preprocessing of the first point cloud data and the plurality of second point cloud data; and a step of performing calibration of the preprocessed first point cloud data and the preprocessed plurality of second point cloud data.

According to still another embodiment of the present disclosure, the software 280a or 280b resident in the memory 255 or stored in the storage 275 may be a computer program recorded in the computer-readable recording medium that causes the processor 250 to execute: a step of generating a first feature map based on point cloud data acquired from the LiDAR sensor and an image captured by the camera, and a step of generating a third feature map by mapping the first feature map to a second feature map generated from pre-stored point cloud data.

More specifically, the processor 250 may include an Application-Specific Integrated Circuit (ASIC), another chipset, a logic circuit, and/or a data processing device. The memory 255 may include a Read-Only Memory (ROM), a Random Access Memory (RAM), a flash memory, a memory card, a storage medium, and/or another storage device. The transceiver 260 may include a baseband circuit for processing wired and wireless signals. The input/output device 265 may include input devices such as a keyboard, a mouse, and/or a joystick, output devices such as a Liquid Crystal Display (LCD), an Organic Light Emitting Diode (OLED), and/or an Active Matrix OLED (AMOLED), and printing devices such as a printer or a plotter.

When the embodiments of the present disclosure are implemented in software, the above-described methods may be implemented as modules (procedures, functions, and the like) that perform the above-described functions. The modules may reside in the memory 255 and may be executed by the processor 250. The memory 255 may be located inside or outside the processor 250, and may be connected to the processor 250 by various well-known means.

Each component shown in FIG. 3 may be implemented by various means, for example, hardware, firmware, software, or a combination thereof. In the case of implementation by hardware, an embodiment of the present disclosure may be implemented by one or more Application-Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors.

In the case of implementation by firmware or software, an embodiment of the present disclosure may be implemented in the form of modules, procedures, or functions that perform the functions or operations described above, and may be recorded on computer-readable recording media through various computer means. The recording medium may include program instructions, data files, and data structures, either alone or in combination. The program instructions recorded in the recording medium may be specially designed and constructed for the present disclosure, or may be publicly known and available to those skilled in computer software.

For example, the recording medium may include magnetic media such as hard disks, floppy disks, and magnetic tapes; optical media such as Compact Disc Read Only Memory (CD-ROM) and Digital Versatile Discs (DVD); magneto-optical media such as floptical disks; and hardware devices specially configured to store and execute program instructions such as ROM, RAM, and flash memory. Examples of the program instructions include machine code created by a compiler and high-level language code that can be executed by a computer using an interpreter. The hardware devices may be configured to operate as one or more software modules to perform operations of the present disclosure, and vice versa.

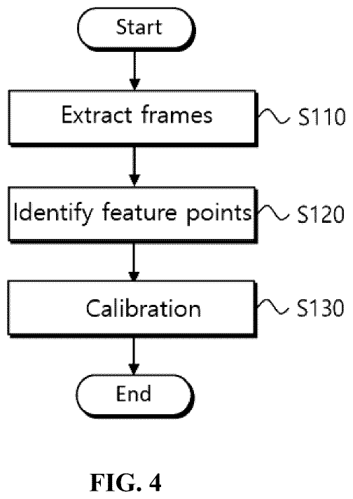

FIG. 4 illustrates a flowchart for explaining a calibration method of a camera and a LiDAR sensor according to an embodiment of the present disclosure. Referring to FIG. 4:

At step S110, the data generation apparatus 200 may extract one frame of an image captured by the camera and one frame of point cloud data acquired by the LiDAR sensor. Each of the extracted image and the extracted frame of point cloud data may include a calibration board.

At step S120, the data generation apparatus 200 may identify feature points of the calibration board included in each of the extracted image and the extracted frame of point cloud data. The calibration board may be a rectangular checkerboard including a border identification region formed of a material having an intensity greater than a predetermined value along a border of the checkerboard, and a top point identification region located at an uppermost portion of the border identification region and formed of a material having an intensity less than the predetermined value.

Specifically, the data generation apparatus 200 may identify corners of the calibration board in the image captured by the camera, based on a size and a number of the calibration boards. The data generation apparatus 200 may identify points corresponding to the corners according to a predetermined pattern based on a feature point located at an uppermost portion or a lowermost portion of the calibration board, and may assign indices to the identified points.

The data generation apparatus 200 may detect the calibration board from the point cloud data based on the border identification region of the calibration board having a relatively high intensity, and may identify feature points within the detected calibration board. Specifically, the data generation apparatus 200 may generate a virtual plane based on point clouds included in the border identification region, may generate a plurality of straight lines by connecting outermost points positioned in each channel on the generated virtual plane, may detect vertices of the calibration board based on intersections of the generated plurality of straight lines, and may identify feature points of the calibration board based on the detected vertices.

That is, the data generation apparatus 200 may identify four vertices included in the calibration board, and may identify feature points of the calibration board based on a size and a number of calibration boards stored in advance. Feature points of the calibration board identified from the point cloud data may correspond to feature points identified from the image. The data generation apparatus 200 may match indices of the feature points identified from the image to the feature points identified from the LiDAR sensor based on the top point identification region of the calibration board.

At step S130, the data generation apparatus 200 may perform calibration of the camera and the LiDAR sensor based on feature points identified from each of the image and the point cloud data. Specifically, the data generation apparatus 200 may calculate extrinsic parameters including a rotation value and a translation value based on the feature points of the calibration board included in the image and the point cloud data, and may perform calibration based on the calculated extrinsic parameters. The data generation apparatus 200 may calculate the rotation value and the translation value separately, and preferably may calculate the translation value after calculating the rotation value.

First, when the rotation value is defined as a rotation value from a first viewpoint to a second viewpoint, the rotation value may be calculated by using Equation (1) below.

$$\vert ( {f}_{1} * {Rf}_{1}^{′} ) ( {f}_{2} * {RF}^{′} 2 ) ( {f}_{3} * {Rf}_{3}^{′} ) \vert = 0 \qquad [ Equation 1 ]$$

In Equation (1), R denotes the rotation value, and ƒ and ƒ′ denote rays from the first viewpoint and the second viewpoint, respectively, to feature points of the calibration board included in the point cloud data.

A translation value may be calculated by using a loss function based on a Re-Projection Error (RPE). The RPE may denote a degree of distortion of a point projected onto an image with respect to a point observed in the image.

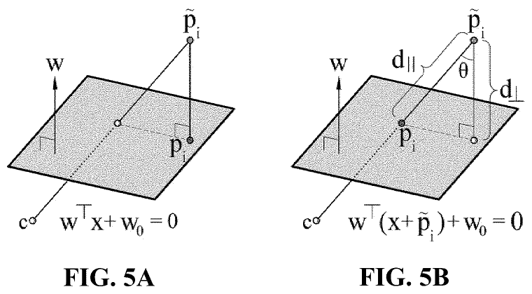

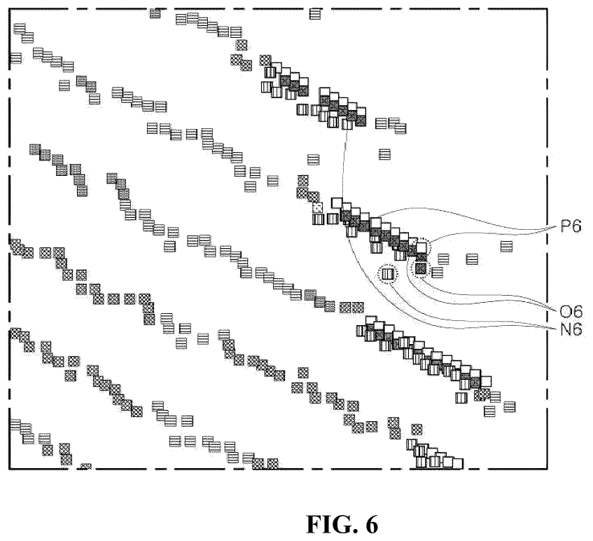

FIGS. 5(a) and 5(b) illustrate perspective projection according to an embodiment of the present disclosure, and FIG. 6 illustrates a comparison of effects between perspective projection and orthogonal projection according to an embodiment of the present disclosure.

Accurate calibration of parameters of the LiDAR sensor and the camera is very important for fusing data obtained from the two sensors. Many conventional calibration methods employ an orthogonal projection method when projecting LiDAR points onto a target plane. However, the orthogonal projection method fails to consider inherent characteristics of LiDAR data, which may cause degradation of calibration accuracy.

In the present disclosure, calibration accuracy is improved by employing a perspective projection method that considers characteristics of LiDAR data. The perspective projection method accurately models a ray casting process in which a laser pulse emitted from the LiDAR sensor is reflected by an object and returns to the LiDAR sensor. Therefore, compared with orthogonal projection, the perspective projection method may better reflect characteristics of the LiDAR data.

The orthogonal projection method simply projects LiDAR points perpendicularly onto a target plane without considering distance information and angle information between the LiDAR sensor and measured LiDAR points. When noise exists in the LiDAR data, the orthogonal projection method may calculate inaccurate positions of projected LiDAR points.

When the target plane is not perpendicular to a central axis of the LiDAR sensor or when the target plane is located close to the LiDAR sensor, errors of the orthogonal projection method become more significant.

A key feature of the present disclosure is the use of a perspective projection method that considers characteristics of the LiDAR data when projecting LiDAR points onto the target plane. Equation (2) below represents a distance ratio between orthogonal projection and perspective projection.

$$\frac{{d}_{⊥}}{{d}_{\vert \vert}} = \frac{\vert {w}^{⊤} ( {\tilde{p}}_{i} - c ) \vert}{‖ w ‖ ‖ {\tilde{p}}_{i} - c ‖} = cos θ \qquad [ Equation 2 ]$$

Referring to FIGS. 5(a), 5(b), and Equation (2), d⊥ denotes an orthogonal distance from a LiDAR point to a target plane, d∥ denotes a perspective distance, and θ denotes an angle (0≤θ<π) between a normal vector (w) of the target plane and a ray direction (pi−c).

In Equation (2), when θ=0, that is, when the ray direction is parallel to the normal vector of the target plane, the orthogonal projection and the perspective projection are identical (d⊥=d∥). However, as θ increases, that is, as the ray direction deviates from the normal vector of the target plane, a difference between the orthogonal projection and the perspective projection increases. Therefore, when the target plane is not perpendicular to a central axis of the LiDAR sensor or when the target plane is located close to the LiDAR sensor, the perspective projection may provide more accurate results.

Since the LiDAR sensor measures distance by using rays, Time of Flight measurement noise occurs along the ray direction. Accordingly, the perspective projection reflects characteristics of LiDAR data more accurately than the orthogonal projection, thereby providing more precise information regarding the target plane.

In the present disclosure, when an angle between the ray direction of the LiDAR sensor and the normal vector of the target plane exceeds a predetermined angle, the point cloud data is projected onto the target plane by using the perspective projection method. The perspective projection method employed in the present disclosure projects LiDAR points by calculating an intersection between a ray connecting the center of the LiDAR sensor and measured LiDAR points and the target plane.

The perspective projection method has advantages over the orthogonal projection method because the perspective projection method faithfully reflects the ray casting process of the LiDAR sensor. Since the perspective projection method considers a direction of a laser emitted from the LiDAR sensor, the perspective projection method is less susceptible to noise compared with the orthogonal projection method. Even when noise exists in measured LiDAR points, the processor may project the LiDAR points onto more accurate positions by using the perspective projection method.

Although the orthogonal projection method may provide different projection results depending on an angle of the target plane, the perspective projection method provides consistent results regardless of the angle of the target plane. The processor may accurately project the LiDAR points by using the perspective projection method, regardless of how the angle of the target plane changes.

Experimental results also confirmed superiority of the perspective projection method. As LiDAR noise increases or as an angle of the target plane deviates from the central axis of the LiDAR sensor, the perspective projection method provides more accurate and consistent results.

FIG. 6 illustrates a comparison between projection results produced by the perspective projection method according to the present disclosure and projection results produced by the conventional orthogonal projection method.

Referring to FIG. 6, LiDAR points of the calibration board are color-coded according to intensity. LiDAR points measured on reflective tape attached to the calibration board include noise (N6). Points including such noise (N6) were projected onto the target plane by using two projection methods, namely the perspective projection method according to the present disclosure and the conventional orthogonal projection method. FIG. 6 indicates points (P6) projected by using the perspective projection method, and points (O6) projected by using the orthogonal projection method. As confirmed in FIG. 6, the perspective-projected points (P6) are distributed uniformly, whereas the orthogonally projected points (O6) are dispersed non-uniformly. The comparison results in FIG. 6 demonstrate that the perspective projection method is less sensitive to noise of LiDAR data. In particular, in a region indicated by a circle in FIG. 6 in which noise is significant, the perspective projection method causes projected points to be distributed on the target plane more uniformly and accurately than the orthogonal projection method.

Descriptions below set forth operations of the perspective projection according to the present disclosure in detail. Referring to FIG. 5, the processor of the data generation apparatus first acquires a three-dimensional point cloud of a surrounding environment by using the LiDAR sensor. Subsequently, the processor detects the target region in the three-dimensional point cloud in which the target object used for calibration is located. For example, the processor may automatically detect the target region by attaching reflective tape around the target object.

At step S701, the processor estimates a normal vector w of the target plane and a constant value w0 by applying a RANSAC algorithm to LiDAR points belonging to the target region. The RANSAC algorithm is a plane estimation method robust to outliers, in which multiple sample points are randomly selected to estimate a plane, and a number of inliers to a plane equation obtained from the estimation is calculated to determine an optimal plane.

At step S701, the processor calculates a point on the target plane by using the estimated normal vector w, the constant value w0, and a measured LiDAR point pi, such that w(x+pi)+w0=0 is satisfied.

$${w}^{⊤} ( x + {\tilde{p}}_{i} ) + {w}_{0} = 0. \qquad [ Equation 3 ]$$

Referring to Equation 3, since a process of translating a center of the LiDAR sensor to an origin is performed, the equation is expressed in a form including a pi term.

The point is expressed in a form including a pi term as a result of translating a center of the LiDAR sensor to an origin. The processor extracts feature points of the target by using the points on the target plane calculated in this manner. The processor acquires an image by using the camera and extracts feature points of the target from the acquired image. Finally, the processor calculates parameters of the LiDAR sensor and the camera by using correspondences between the feature points of the target extracted from the LiDAR sensor and the feature points of the target extracted from the camera.

The calibration method according to the present disclosure particularly employs the perspective projection method to project LiDAR points onto the target plane. That is, as a method of projecting three-dimensional points in space onto the target plane, the perspective projection method defines a ray between each point and a projection center, and calculates an intersection of the ray with a two-dimensional plane. By considering inherent characteristics of LiDAR data, the perspective projection method improves calibration accuracy.

The processor first detects the target region from a three-dimensional point cloud acquired from the LiDAR sensor, and then estimates the target plane by using LiDAR points belonging to the target region. At step S801, the processor projects each LiDAR point pi on the target plane onto the target plane by using a vector connecting a center coordinate c of the LiDAR sensor and the LiDAR point, together with a Time of Flight ti. At step S802, the processor continues the projection process by applying the vector and the Time of Flight ti. At step S803, the processor calculates coordinates pi of the projected LiDAR point.

The LiDAR sensor emits laser beams to measure distances to objects, and generates a three-dimensional point cloud by using the measured distance information. The Time of Flight (ToF) denotes a time taken for a laser pulse to be emitted from the LiDAR sensor, travel to a measured LiDAR point, and return.

The processor calculates three-dimensional coordinates pi of the projected LiDAR point by using Equation 4 below:

$${p}_{i} = - ( {\tilde{p}}_{i} - c ) {t}_{i} \qquad [ Equation 4 ]$$

Equation 4 represents a method of calculating three-dimensional coordinates of an intersection point when a LiDAR point is projected onto the target plane along a ray passing through a center of the LiDAR sensor. Specifically, a distance vector traveled by a laser pulse is calculated by multiplying a vector (pi−c) connecting a LiDAR center c and a measured LiDAR point pi by a Time of Flight (ti). To calculate coordinates when the LiDAR center is translated to an origin, a negative sign is applied to the vector (pi−c)·ti.

This perspective projection method accurately reflects characteristics of LiDAR data and enables acquisition of accurate information about the target plane. At step S804, the processor extracts feature points of the target by using the calculated LiDAR points. The processor extracts feature points of the target from an image acquired by using the camera. Finally, the processor calculates parameters of the LiDAR sensor and the camera by using correspondences between the feature points of the target extracted from the LiDAR sensor and the feature points of the target extracted from the camera.

Since data acquired from the LiDAR sensor is based on distance information measured by using laser pulses, it is important to consider a relationship between a position of the sensor and each measured point. This relationship is expressed as a ray, and the perspective projection method projects three-dimensional points onto a two-dimensional plane by using the ray.

The processor calculates a Time of Flight (ToF) based on Equation 5 below:

$${t}_{i} = \frac{{w}^{⊤} {\tilde{p}}_{i} + {w}_{0}}{{w}^{⊤} ( {\tilde{p}}_{i} - c )} \qquad [ Equation 5 ]$$

Equation 5 represents a method of projecting noisy LiDAR points onto the target plane by calculating an intersection between a laser emitted from the LiDAR sensor and the target plane. Specifically, a line connecting a sensor center c and a measured LiDAR point pi is defined, and an intersection of the line with the target plane is calculated.

In Equation 5, ti denotes a time taken for a laser pulse to be emitted from the LiDAR sensor, reflected by an object, and returned. wT denotes a normal vector of the target plane, pi denotes a measured LiDAR point, w0 denotes a constant term of an equation of the target plane, and c denotes a center coordinate of the LiDAR sensor.

The processor detects the target region from a three-dimensional point cloud acquired from the LiDAR sensor, and estimates the target plane by using LiDAR points belonging to the target region. At step S901, the processor derives a ray vector connecting a center coordinate c of the LiDAR sensor and each LiDAR point pi on the target plane, together with a normal vector w of the target plane. At step S902, the processor calculates a perspective projection distance d∥.

The perspective projection distance d∥ denotes a distance from a sensor center to an intersection point when a point in three-dimensional space is projected onto the target plane along a ray passing through the LiDAR center.

The processor calculates a perspective projection distance by using Equation 6 below:

$${d}_{\vert \vert} = \vert \frac{{w}^{⊤} {\tilde{p}}_{i} + {w}_{0}}{{w}^{⊤} ( {\tilde{p}}_{i} - c )} \vert ‖ {\tilde{p}}_{i} - c ‖ \qquad [ Equation 6 ]$$

Equation 6 presents a method of accurately calculating a perspective projection distance by considering characteristics of LiDAR data. A conventional orthogonal projection method may generate inaccurate results when noise exists in measured LiDAR points, because the conventional orthogonal projection method does not consider directions of laser pulses emitted from the LiDAR sensor.

Referring to Equation 6, d∥ denotes the perspective projection distance, w denotes a normal vector of the target plane, pi denotes a measured LiDAR point, w0 denotes a constant term of an equation of the target plane, and C denotes a center of the LiDAR sensor. At step S903, the processor projects LiDAR points onto the target plane by using the calculated perspective projection distance d∥.

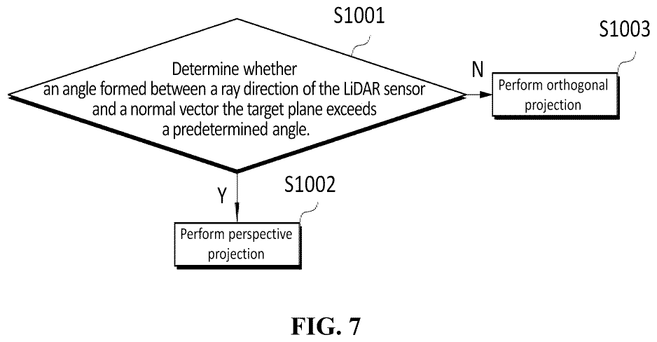

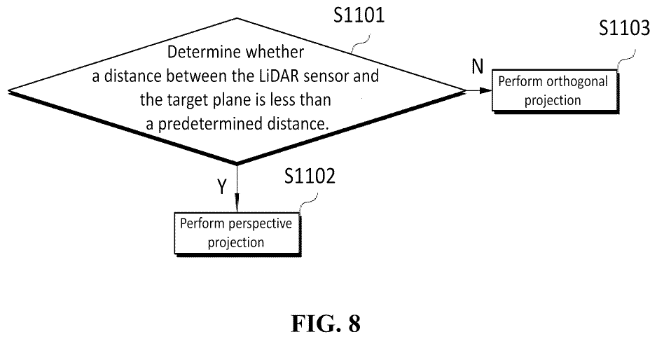

FIG. 7 and FIG. 8 are diagrams illustrating execution of perspective projection under specific conditions according to an embodiment of the present disclosure.

According to an embodiment of the present disclosure, projection may be adaptively adjusted by considering both a distance between the LiDAR sensor and the target plane, and an angle between a ray direction of the LiDAR sensor and a normal vector of the target plane. Specifically, during a step of performing calibration, the processor first calculates an angle formed between a ray direction of the LiDAR sensor and a normal vector of the target plane.

At step S1001, when the calculated angle exceeds a predetermined threshold angle, the processor projects point cloud data onto the target plane by using perspective projection. At step S1002, the perspective projection is applied to perform such projection. At step S1003, when the calculated angle does not exceed the threshold angle, orthogonal projection may be performed depending on an operation mode.

Perspective projection is a method of projection that reflects scale variation according to distance, in which an object located farther away is projected smaller. Accordingly, accurate projection results can be obtained even when the LiDAR sensor is tilted.

Conversely, when a distance between the LiDAR sensor and the target plane is less than a predetermined threshold distance, the processor projects LiDAR point coordinates onto the target plane by using perspective projection. At step S1101, such projection condition is determined. At step S1102, the processor applies perspective projection to the LiDAR point coordinates. At step S1103, when the distance exceeds the threshold distance, orthogonal projection may be performed depending on an operation mode.

Based on such operations, calibration can be performed in various environments by adaptively adjusting projection according to a distance and an angle between the LiDAR sensor and the target plane.

Hereinafter, operations related to augmented points according to another embodiment of the present disclosure will be described.

In the present disclosure, the term “point” denotes information constituting point cloud data acquired by the LiDAR sensor. A “feature point” denotes a point constituting the calibration board, derived from the points, and used as a reference point for calibration.

The present disclosure relates to a method for more accurately performing calibration between the LiDAR sensor and the camera sensor. In particular, by generating augmented points using edge points of the calibration target and by re-determining feature points based on the augmented points, quantization errors of the LiDAR sensor can be effectively compensated.

The processor first captures the calibration target by using the camera sensor, and acquires point cloud data of the calibration target by using the LiDAR sensor. The calibration target may be a planar object having a known pattern, such as a checkerboard. The acquired point cloud data is projected onto a plane of the calibration target and is transformed into a two-dimensional coordinate system. This may be performed by estimating a plane equation of the calibration target and projecting each point cloud onto the plane.

The processor extracts edge points of the calibration target by using the point cloud data transformed into the two-dimensional coordinate system. The edge points may be detected based on density variations and distance discontinuities of the point cloud data. For example, when a distance variation between adjacent points in each scan line exceeds a predetermined threshold, the processor may determine the corresponding point as an edge point.

The processor generates an augmented point for each extracted edge point by using a previous edge point on the same scan line. The augmented point is generated at a position extended beyond a boundary of the calibration target. Specifically, a virtual point is generated outside a boundary of the calibration target by extending a straight line connecting a current edge point and a previous edge point. The augmented point serves to compensate for positional errors of edge points caused by quantization errors of the LiDAR sensor.

The processor corrects feature points of the calibration target by using edge points and augmented points. The feature points correspond to corners of the calibration target, and are used as reference points required for calibration.

By correcting positions of the edge points by using the augmented points, positions of the feature points can be estimated more accurately. For example, the processor may approximate the edge points to straight lines by using a RANSAC algorithm, and may calculate intersections of the straight lines to correct the feature points.

The processor calculates parameters between the LiDAR sensor and the camera sensor by using the re-determined feature points. The parameters represent relative positional and directional relationships between the two sensors, and include a rotation matrix and a translation vector. Since the corrected feature points can also be detected in camera images, the processor may calculate the parameters by using coordinates of the feature points detected in both sensors. For this calculation, computer vision techniques such as a Perspective-n-Point (PnP) algorithm may be used.

By using the calculated parameters, LiDAR point cloud data is projected onto a camera image, and calibration results are verified by evaluating a degree of alignment between the projected point cloud data and the camera image. When the degree of alignment is low, calibration results may be improved by repeating the calibration process or by adjusting the parameters.

The calibration method between the LiDAR sensor and the camera sensor according to the present disclosure may be utilized in various fields such as autonomous driving, robotics, and three-dimensional map generation.

The processor extracts edge points of the calibration target by using point cloud data transformed into a two-dimensional coordinate system. The edge points may be detected based on density variations and distance discontinuities of the point cloud data. For example, when a distance variation between adjacent points in each scan line exceeds a predetermined threshold, the processor may determine the corresponding point as an edge point.

The processor may determine augmented points for each extracted edge point pl_i and pr_i based on Equation 7 below:

$${q}_{i}^{l} = {p}_{i}^{l} + ( {p}_{i}^{l} - {p}_{i}^{l - 1} ) , {q}_{i}^{r} = {p}_{i}^{r} + ( {p}_{i}^{r} - {p}_{i}^{r - 1} ) \qquad [ Equation 7 ]$$

Referring to Equation 7, ql_i denotes a left augmented point of a scan line, qr_i denotes a right augmented point of the scan line, pl_i denotes a left feature point of the scan line, pr_i denotes a right feature point of the scan line, pl−1_i denotes a left edge point of an (l−1)th scan line, and pr−1_i denotes a right edge point of an (r−1)th scan line.

Equation 7 provides a method for calculating augmented points to solve such a problem. The processor may generate a point closer to an actual boundary line by extrapolating an edge point in a measured direction by using the augmented points.

The processor may calculate augmented points in order to more accurately estimate a boundary of the calibration target by using LiDAR data. The LiDAR data consists of distance information measured for each channel angle, and has a discrete rather than continuous form. Accordingly, edge points extracted based on distance discontinuities in each channel are not located on the actual boundary line, but are located inside the actual boundary line.

The processor may generate a point closer to the actual boundary line by extrapolating the edge point in a measured direction by using the augmented points. The processor may generate augmented points by calculating a vector between an edge point of a current scan line and an edge point of a previous scan line by using Equation 7, and by extrapolating by an amount corresponding to the vector between the edge points of the scan lines. That is, the processor may generate augmented points at extrapolated positions corresponding to vectors between the edge points of the scan lines.

The processor enables more accurate boundary estimation by constraining a boundary line of the calibration target to pass between an edge point and an augmented point generated as described above, by using the augmented points together with the edge points.

A boundary estimation method using the augmented points becomes more effective as the calibration target is located farther away from the LiDAR sensor. As the target becomes more distant from the sensor, a distance between the edge points and the augmented points increases, thereby enabling a boundary line to be constrained more accurately.

The processor first detects edge points of the calibration target by using LiDAR data, and estimates initial feature points of the calibration target by using the detected edge points. However, due to characteristics of LiDAR data, the edge points are located inside an actual boundary line of the calibration target, and therefore the initial feature points may include positional errors relative to actual positions.

In order to reduce such errors, the processor generates augmented points for each edge point by using Equation 7 described above. The augmented points are located on straight lines extended in directions of boundary lines of the calibration target from the edge points, and are located closer to the actual boundary line than the edge points.

Meanwhile, Equation 8 defines an edge-based cost function Eedge used to accurately find a plane boundary line.

$${E}_{edge} = {\sum }_{i = 1}^{c} d ( {l}^{l} , {p}_{i}^{l} ) + d ( {l}^{l} , {q}_{i}^{l} ) + d ( {l}^{r} , {p}_{i}^{r} ) + d ( {l}^{r} , {q}_{i}^{r} ) \qquad [ Equation 8 ]$$

Equation 8 may be used to set a constraint such that a boundary line passes between an edge point and an augmented point.

In the equation, c denotes a number of LiDAR channels scanning the target plane, l and r denote left and right boundary lines defined as corner points, and d(l, p) denotes a distance between a line l and a point p along a scan line.

When a boundary line is located between an edge point and an augmented point, a cost function has a minimum value. When the boundary line deviates from this range, a value of the cost function increases. Accordingly, the processor may define the boundary line of the target to be located between the edge point and the augmented point.

Referring to Equation 8, a value of dout+din in a case of ci becomes smaller than a value of dout+din in a case of ci+1. The case of ci satisfies the constraint of Equation 8, while the case of ci+1 does not satisfy the constraint of Equation 8, and therefore the edge points and augmented points need to be re-determined.

Meanwhile, a position-based loss function may be defined as follows.

$${E}_{position} = {\sum }_{i = 1}^{4} ‖ {c}_{i} - {\overline{c}}_{i} ‖ \qquad [ Equation 9 ]$$

Equation 9 may represent Eposition as a sum of a distance between a feature point and a nearest edge point, and a distance between the feature point and an augmented point.

The processor may re-determine the feature points by minimizing Eedge by using the generated augmented points and the edge points.

Eedge is defined as a sum of distances from each edge point and augmented point to left and right feature points, and by minimizing Eedge, the feature points may be adjusted closer to an actual boundary line.

Additionally, the processor may re-determine the feature points by using the equation below.

$$E = {E}_{edge} + λ {E}_{position} \qquad [ Equation 10 ]$$

Referring to Equation 10, Eposition denotes a sum of a distance between a feature point and a nearest edge point, and a distance between the feature point and an augmented point, while λ denotes a parameter for adjusting weights of the two cost functions.

Accordingly, the processor may determine the feature points based on a distance Eedge between a boundary line of the target and edge points and augmented points, and a distance Eposition between the feature points and the edge points and the augmented points.

The processor may perform calibration between the LiDAR sensor and the camera sensor by using size information of the calibration board. The processor first acquires the size information of the calibration board. This information may be provided by a manufacturer of the calibration board, or may be directly measured and input by a user.

The processor may calculate parameters between the LiDAR sensor and the camera sensor and perform calibration by using the acquired size information of the calibration board.

A method of calculating parameters by using the calibration board is as follows. The processor simultaneously acquires LiDAR data and camera image data. The processor extracts feature points of the calibration board from the acquired data. The processor calculates a transformation relationship between the LiDAR sensor and the camera sensor by using three-dimensional position information and two-dimensional image coordinate information of the extracted feature points.

Size information of the calibration board is used to accurately calculate the three-dimensional position information of the feature points of the calibration board. As a result, the processor may accurately calculate parameters between the LiDAR sensor and the camera sensor by using the size information of the calibration board, thereby improving performance of a sensor fusion system.

The processor may further improve accuracy by sequentially performing rotation calibration and translation calibration between the LiDAR sensor and the camera sensor. The processor first extracts feature points from image data and point cloud data. Subsequently, the processor performs rotation calibration based on the extracted feature points, and calculates a rotational transformation relationship between the LiDAR sensor and the camera sensor. After completion of the rotation calibration, the processor performs translation calibration, and calculates a translational transformation relationship between the LiDAR sensor and the camera sensor.

In particular, when the LiDAR sensor and the camera sensor are arranged in parallel, a translational offset is very small, and thus it may be difficult to calculate an essential matrix. In this case, the processor may secure robustness of calibration by first estimating a relative transformation using rotational constraints.

Meanwhile, conventional calibration methods were sensitive to initial guesses and had a drawback of being susceptible to a local minima problem. The calibration method according to the present disclosure employs a Particle Swarm Optimization (PSO) algorithm to address such drawbacks. The PSO algorithm may perform optimization stably and efficiently without requiring an initial guess, and has an advantage of being less sensitive to the local minima problem.

The calibration method according to the present disclosure includes the following steps. First, the target plane is positioned at an origin of a LiDAR coordinate system. Subsequently, the processor optimizes rotation and translational transformations of the LiDAR sensor by using the PSO algorithm. The PSO algorithm uses a plurality of “particles” to efficiently explore a search space, and each particle represents candidate values of the rotation and translational transformation parameters. The particles move in directions that minimize a cost function, and an optimal set of rotation and translational transformation parameters is determined by minimizing an overall cost function E.

The overall cost function, as described above, is composed of a base cost function Eedge and a position-based cost function Eposition, and is defined as E=Eedge+ė Eposition. The edge-based cost function is calculated by using edge points and augmented points, and the position-based cost function constrains estimated corner points to be close to initial estimates. Finally, calibration between the LiDAR sensor and the target plane is completed by using optimized rotation and translational transformation parameters.

According to the present disclosure, calibration between the LiDAR sensor and the target plane may be performed stably and efficiently without requiring an initial guess. In addition, since the calibration method is less sensitive to the local minima problem, more accurate calibration results can be obtained.

As a result, the processor may accurately perform calibration between the LiDAR sensor and the camera sensor by sequentially performing rotation calibration and translation calibration.

The processor first estimates a rotational transformation relationship between the LiDAR sensor and the camera sensor by using a Translation Independent Rotation Constraint technique. This technique addresses a problem in which calculation of an essential matrix becomes difficult when the LiDAR sensor and the camera sensor are arranged in parallel and a translational offset is very small.

The processor constructs epipolar planes by using three-dimensional to two-dimensional (3D-2D) correspondences, and calculates normal vectors of the respective epipolar planes. Since the normal vectors are all perpendicular to a translational vector, an eigenvector corresponding to a minimum eigenvalue of a covariance matrix of the normal vectors represents a direction of the translational vector.

The processor may perform translational calibration between the LiDAR sensor and the camera by using the eigenvector corresponding to the minimum eigenvalue of the covariance matrix of the normal vectors of the epipolar planes.

The processor calculates a magnitude of the translational vector by using the estimated translational vector direction together with the 3D-2D correspondences, and finally estimates both a rotational transformation relationship and a translational transformation relationship between the LiDAR sensor and the camera sensor.

Accordingly, the processor may sequentially perform rotation calibration and translational calibration by using the above-described method.

Equation 11 illustrates a process of finely adjusting the estimated parameters by using a Perspective-n-Point (PnP) algorithm.

$$min {\sum }_{i = 1}^{m} {‖ {}^{C} {f}_{i} - π ( {R}_{L}^{CL} {f}_{i} + {}^{C} {t}_{CL} ‖}^{2} \qquad [ Equation 11 ]$$

Referring to Equation 11, Cfi denotes normalized coordinates of an i-th camera image feature point, Lfi denotes three-dimensional coordinates of an i-th LiDAR point cloud feature point, R\hat{ }{CL} denotes a rotational transformation matrix from a LiDAR coordinate system to a camera sensor coordinate system, t\hat{ }{CL} denotes a translational transformation vector from the LiDAR coordinate system to the camera sensor coordinate system, and π(⋅) denotes a projection function onto a camera image plane.

The processor finely adjusts the parameters by minimizing a reprojection error of Equation 11 by using a nonlinear optimization technique such as a Levenberg-Marquardt algorithm. As a result, the processor may perform calibration between the LiDAR sensor and the camera sensor more accurately through a coarse-to-fine parameter optimization process.

As described above, preferred embodiments of the present disclosure have been disclosed in this specification and drawings. However, it should be apparent to those of ordinary skill in the art that other modifications based on the technical spirit of the present disclosure may also be implemented in addition to the embodiments disclosed herein. Furthermore, specific terms used in the specification and drawings are intended for ease of explanation of the technical contents of the present disclosure and for aiding in understanding of the invention, and are not intended to limit the scope of the present disclosure. Accordingly, the detailed description set forth above should not be interpreted as limiting in all aspects, but should be considered as illustrative. The scope of the present disclosure should be determined by a reasonable interpretation of the appended claims, and all modifications within an equivalent scope of the present disclosure should be included in the scope of the present disclosure.

What is claimed is:

1. A server, comprising:
a memory; and
at least one processor communicatively coupled to a camera, a LiDAR sensor, and the memory,
wherein the at least one processor is configured to:
extract one frame of an image acquired by the camera and one frame of point cloud data acquired by the LiDAR sensor, wherein the point cloud data comprises a plurality of LiDAR points;
identify feature points of a calibration board included in each of the extracted frame of the image and the extracted frame of the point cloud data;
perform calibration of the camera and the LiDAR sensor based on the identified feature points;
generate a target plane by using a RANSAC algorithm based on the feature points;
project, based on a relationship between the point cloud data and the target plane, the point cloud data onto the target plane by performing a perspective projection; and
wherein the image is acquired from the camera, the point cloud data is acquired from the LiDAR sensor, and the predetermined algorithm is the RANSAC algorithm.

2. The server of claim 1, wherein the at least one processor is configured to:
project by using at least one of a perspective projection method and an orthogonal projection method; and
when an angle formed between a ray direction of the LiDAR sensor and a normal vector of the target plane exceeds a predetermined angle, project the point cloud data onto the target plane by performing the perspective projection.

3. The server of claim 2, wherein the at least one processor is configured to, when a distance between the LiDAR sensor and the target plane is less than a predetermined distance, project the plurality of LiDAR points onto the target plane by performing the perspective projection.

4. The server of claim 1, wherein the at least one processor is configured to:
determine a normal vector and a constant value of the target plane by using the plurality of LiDAR points belonging to the target plane; and
determine an equation of the target plane based on the normal vector, the constant value, and a measured LiDAR point.

5. The server of claim 2, wherein the at least one processor is configured to:
project each of the plurality of LiDAR points onto the target plane by using a vector connecting a center coordinate of the LiDAR sensor and the respective LiDAR point, and a Time of Flight (ToF).

6. The server of claim 1, wherein the at least one processor is configured to:
calculate a perspective projection distance for each LiDAR point coordinate on the target plane based on a ray vector connecting a center coordinate of the LiDAR sensor and the LiDAR point coordinate, and a normal vector of the target plane; and
project the LiDAR point coordinate onto the target plane by using the calculated perspective projection distance.

7. The server of claim 1, wherein the at least one processor is configured to:
when an angle between a ray direction of the LiDAR sensor and a normal vector of the target plane exceeds a predetermined angle, project the point cloud data onto the target plane by performing the perspective projection.

8. The server of claim 7, wherein the at least one processor is configured to:
when a distance between the LiDAR sensor and the target plane is less than a predetermined distance, project the plurality of LiDAR points onto the target plane by performing the perspective projection.

9. The server of claim 1, wherein the at least one processor is configured to:
calculate extrinsic parameters including a rotation value and a translation value, based on the feature points included in each of the image and the point cloud data; and
perform the calibration based on the calculated extrinsic parameters.

10. A calibration method comprising:
extracting, by a server, one frame of an image acquired by a camera and one frame of point cloud data acquired by a LiDAR sensor, wherein the point cloud data comprises a plurality of LiDAR points;
identifying, by the server, feature points of a calibration board included in each of the extracted frame of the image and the extracted frame of the point cloud data; and performing, by the server, calibration of the camera and the LiDAR sensor based on the identified feature points,
wherein performing the calibration comprises the steps of:
generating a target plane by using a RANSAC algorithm based on the feature points; and
when an angle between a ray direction of the LiDAR sensor and a normal vector of the target plane exceeds a predetermined angle, projecting the point cloud data onto the target plane by performing a perspective projection.
